(19) United States
(12) Patent Application Publication
(10) Pub. No.: US 2006/0133912 A1
(43) Pub. Date: Jun. 22, 2006

(54) Circumferentially balanced, take-up device

(76) Inventor: Alfred D. Commins, Friday Harbor, WA (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 11/325,257

(22) Filed: Jan. 3, 2006

Related U.S. Application Data
(63) Continuation-in-part of application No. 10/602,534, filed on Jun. 23, 2003, now Pat. No. 7,037,060.
(60) Provisional application No. 60/641,090, filed on Jan. 3, 2005.

(51) Int. Cl. F16B 43/00

(52) U.S. Cl. 411/536

(57) ABSTRACT

An apparatus that is expandable axially along an anchor between a surface and a retainer fastened to the anchor is disclosed in one aspect of the present invention as including a base member; a slide member that slides relative to the base member to effect a change in height of the apparatus; a load-transfer mechanism to transfer a load from the base member to the slide member, the load-transfer mechanism providing substantially balanced axial support to the slide member along a circumferential direction regardless of the height of the apparatus; and a biasing member to urge the slide member with respect to the base member to increase the height of the apparatus.

### 1. RELATED APPLICATIONS

This application is a continuation-in-part of U.S. patent application Ser. No. 10/602,534 filed on Jun. 23, 2003 and entitled SHRINKAGE COMPENSATOR FOR BUILDING TIEDOWNS. This application also claims priority to U.S. Provisional Patent Application Ser. No. 60/641,090, filed on Jan. 3, 2005, and entitled HYDRAULIC TAKE-UP APPARATUS AND METHOD.

### BACKGROUND

1. The Field of the Invention

This invention pertains to building construction, and, more particularly, to novel methods and apparatus for anchoring building walls to foundations and lower floors thereof. The invention provides an automatic adjusting mechanism to remove slack in a hold down system caused by wood shrinkage over time or wood crushing caused by earthquakes.

2. The Background Art

Wood products change dimensions as moisture content changes. Floor systems using solid sawn joists typically shrink approximately five percent in dimensions across the grain. Under certain conditions they have been known to shrink six and one-half percent within a year. This shrinkage is typically part of the overall process and condition called “settling.” Settling actually includes both settling of foundations, as well as settling of walls due to shrinkage.

Testing and load rating has been completed for shear walls mounted to solid underlying surfaces. The solid surfaces are typically comprised of steel, concrete, or both. In tests wherein a wall is constructed, and immediately tested thereafter, test results are substantially better than those for walls that have existed over time. In a typical practice, a sill plate anchor or lower anchor is a threaded rod or an anchored strap capturing the base plate or sill plate of a wall (the bottom, horizontal member above which the studs extend vertically). Over time, ranging from several months to several years, wood loses moisture, shrinks, and the building settles. Threaded rod type anchors become loose. Strap type anchors buckle if positively engaged and become loaded in compression, or the like.

Current tiedown systems (including rods, straps, and the like) do not provide a solution for this problem. After a building “settles” the wall can lift before it will re-engage the hold down structure before the tiedown is even loaded to begin resisting movement of the wall. Substantial building damage can result before the anchoring hardware is loaded (in tension). Hardware that does not immediately engage the base of an anchored wall can result in a 50 percent to 70 percent loss in lateral, load-bearing capacity.

The problem arises, typically, in wind storms of great power, or in earthquake conditions. A building under such circumstances may be violently loaded or shaken back and forth in a lateral direction with respect to the extent of the wall. If a shearwall is tightly restrained by its base to a foundation, loads may be smoothly transferred from a horizontal to a vertical direction. Loads are resolved in the foundation, where they appear as tension and compression forces.

Buildings are often composed of long walls, (walls with a length greater than the height) and short walls (walls that have a length shorter than the height). The uplift load on a particular wall is inversely proportional to the length of the wall. Tall narrow shear walls (as commonly found in nearly all homes) act as lever arms and tend to magnify the input load. In certain instances and depending upon wall structural configuration, the actual load on the anchoring system may be magnified to several times the original load. Gaps caused by wood shrinkage may further introduce an undesirable shock load to the anchoring system as the gaps are closed and the anchor system is finally loaded.

However, the as-built building is generally not the building that will be sustaining loads induced by earthquake shaking or by wind. Wood components of the building structure, including floors, sill plates, top plates, and studs, will shrink. Shrinkage varies greatly but it ranges typically from about one-quarter inch under the best of conditions, to well over one inch.

Moreover, under load, wood crushes or collapses in compression under the loading of a wall. Neither shrinkage nor crushing are well-accommodated or otherwise resolved in currently available systems. These problems lead to a significant reduction in the lateral, load-bearing capacity of shearwalls. Typically, based on testing, load-bearing capacity reductions range from about 30 percent to about 70 percent, depending on whether the rating used corresponds to building codes for property preservation, or life safety.

A better hold down or tiedown system including an improved take-up is needed to accommodate shrinkage of building materials. An improved tiedown system with such an improved take-up mechanism will improve the strength of shear walls subject to shrinkage of constituent materials.

### BRIEF SUMMARY OF THE INVENTION

Consistent with the foregoing, and in accordance with the invention as embodied and broadly described herein, an apparatus that is expandable axially along an anchor between a surface and a retainer fastened to the anchor is disclosed in one aspect of the present invention as including a base member; a slide member that slides relative to the base member to effect a change in height of the apparatus; a load-transfer mechanism to transfer a load from the base member to the slide member, the load-transfer mechanism providing substantially balanced axial support to the slide member along a circumferential direction regardless of the height of the apparatus; and a biasing member to urge the slide member with respect to the base member to increase the height of the apparatus.

In another aspect of the invention, an assembly in accordance with the invention includes a structure comprising a foundation, a structural member, an anchor extending in a first direction from the foundation through the structural member, and a fastener engaging the anchor at a location spaced from the structural member in the first direction. The assembly further includes a take-up unit to occupy excess distance between the structural member and the fastener. The take-up unit includes a base member; a slide member adapted to slide relative to the base member to effect a change in height of the take-up unit; a load-transfer mechanism to transfer an axial load from the base member to the slide member and to distribute the axial load substantially uniformly along a circumferential direction regardless of the height of the apparatus; and a biasing member to urge the slide member with respect to the base member to increase the height of the take-up unit.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view in elevation of an apparatus providing automatic take-up in accordance with the present invention, depicted in two typical deployment arrangements illustrating take-up systems to accommodate shrinkage;

FIG. 2 is a perspective view from above of an apparatus shown in FIG. 1, in a contracted height configuration and with a safety trigger engaged;

FIG. 3 is a perspective view in elevation of an apparatus of FIG. 1, in an expanded height configuration and with a safety trigger disengaged;

FIG. 4 is an exploded assembly view in perspective of an apparatus of FIG. 1;

FIG. 5 is a cross-section view of an apparatus shown in FIG. 1, illustrating manufacturing details of one way to provide a positive restraint against disassembly;

FIG. 6 is a perspective view from below of the apparatus of FIG. 5;

FIG. 7 is a perspective view in elevation illustrating two stacked apparatus of FIG. 1, being configured for increased range of adjustment;

FIG. 8A is a cross-sectional view in elevation of a third take-up mechanism according to the present invention, illustrating a minimum installation height and a safety trigger mechanism;

FIG. 8B is a cross-sectional view in elevation of the apparatus of FIG. 8A, illustrating a maximum take-up height;

FIG. 9 is a side, cross-sectional view of one embodiment of a hydraulic take-up unit in accordance with the present invention, applied to a tie rod extending from a foundation through a sill plate;

FIG. 10 is a side, elevation view of an alternative embodiment of a hydraulic take-up unit in accordance with the present invention, providing the connection between a hold down secured to a vertical support member and a tie rod extending from a foundation through a sill plate;

FIG. 11 is a side, cross-sectional view of one embodiment of a hydraulic take-up unit in accordance with the present invention capable of being installed as illustrated in FIG. 10;

FIG. 12 is a side, cross-sectional view of another embodiment of a hydraulic take-up unit in accordance with the present invention capable of being installed as illustrated in FIG. 10;

FIG. 13 is a side, cross-sectional view of another embodiment of a hydraulic take-up unit in accordance with the present invention;

FIG. 14 is a side, cross-sectional view of another embodiment of a hydraulic take-up unit in accordance with the present invention; and

FIG. 15 is a top view of a hydraulic take-up unit in accordance with the present invention, provided to show the load distribution of both the threaded and hydraulic take-up units along a circumferential direction.

### DETAILED DESCRIPTION OF THE PREFERRED EMBODIMENTS

It will be readily understood that the components of the present invention, as generally described and illustrated in the Figures herein, could be arranged and designed in a wide variety of different configurations. Thus, the following more detailed description of the embodiments of the system and method of the present invention, as represented in 1 through 15, is not intended to limit the scope of the invention. The scope of the invention is as broad as claimed herein. The illustrations are merely representative of certain, presently preferred embodiments of the invention. Those presently preferred embodiments of the invention will be best understood by reference to the drawings, wherein like parts are designated by like numerals throughout.

Those of ordinary skill in the art will, of course, appreciate that various modifications to the details of the Figures may easily be made without departing from the essential characteristics of the invention. Thus, the following description of the Figures is intended only by way of example, and simply illustrates certain presently preferred embodiments consistent with the invention as claimed.

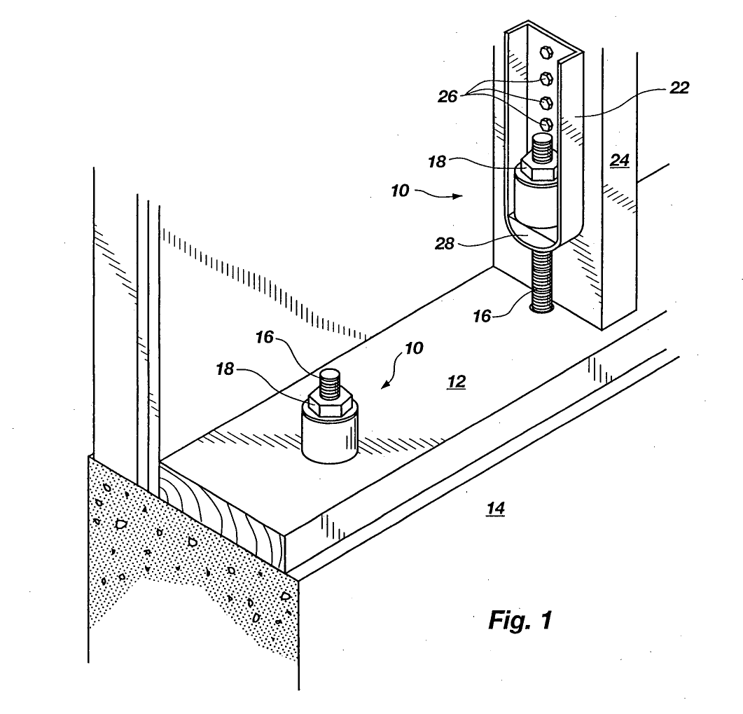

Referring to FIG. 1, a wood shear wall 8 is an engineered assembly of lumber, plywood (or OSB), nails and attachment hardware. Shear walls resist in-plane wind or seismic forces. Loads are transferred from the structure to the shear walls in-plane with the load. As a load is transferred into the wall, the wall will tend to move away from the load. The load therefore induces a rotation or moment in the wall. Wall rotation compresses one corner of the wall while the other corner tends to lift off from the foundation or support. Traditionally, the lower corners of the wall 8 have been held down by straps or hardware. However, as illustrated, the wall 8 may be retained by one or more take-up mechanisms 10, according to the invention, to accommodate structural shrinkage.

FIG. 1 illustrates two workable arrangements for securing an end of an anchor bolt 16. One arrangement simply bolts the sill plate 12 directly to the foundation 14, perhaps also including one or more washers between the retaining nut 18 and a sill plate 12. As illustrated, a take-up unit 10 is also included to compensate for any wood shrinkage. Depending on the loading of the take-up unit 10, a steel plate (not shown) may also be installed underneath the take-up unit 10 to spread out the compressive force of the take-up unit 10 against the sill plate 12. An alternate arrangement is to secure one end of an anchor bolt 16 incorporates a bracket 22. In this arrangement, the bracket 22 is secured to a stud 24 by multiple, spaced-apart fasteners 26. Again, a take-up unit 10 is included in position to compensate for wood shrinkage. A take-up unit 10 may be disposed between a retainer nut 18 and a metal spacer platform base 28 of the illustrated typical commercial retainer arrangement. The wood stud 24 facilitates load transfer into the sill plate by distributing load into the sill plate over the entire stud end.

The illustrated take-up units 10 in FIG. 1 are installed around, and oriented to take up slack in an axial direction of, the anchor bolts 16. The take-up units 10 may be considered to be restrained from radial motion by the anchor bolts 16. Preferred take-up units 10 are capable of extending to a full height, and maintaining such a full height, even in the event that the hold down system is subjected to excessive slack.

FIG. 1 illustrates a sill plate 12 installed directly on top of a foundation 14. This construction presents a minimum thickness of wood subject to shrinkage in the hold down system. An alternate standard method of constructing a building is called platform framing. This method includes building a floor platform on top of a double plated wall and then adding a wall on top of the floor. Since the anchor bolt 16 must then span a greater thickness of wood, a hold down to secure the wall on a floor of such construction is subject to considerable wood shrinkage. In another construction arrangement, a threaded rod 16 or an anchor bolt 16, attached to the foundation on one end, may pass through a sill plate 12, span the thickness of a joist, penetrate a subfloor and floor, and the bottom member of a stud wall 8. The aforementioned wooden members are generally oriented to present a maximum amount of shrinkage to the anchor bolt 16. A combined shrinkage of about three-quarters of an inch would not be atypical in such multilayer construction. Shrinkage as large as one-and-a-quarter inch may even be present.

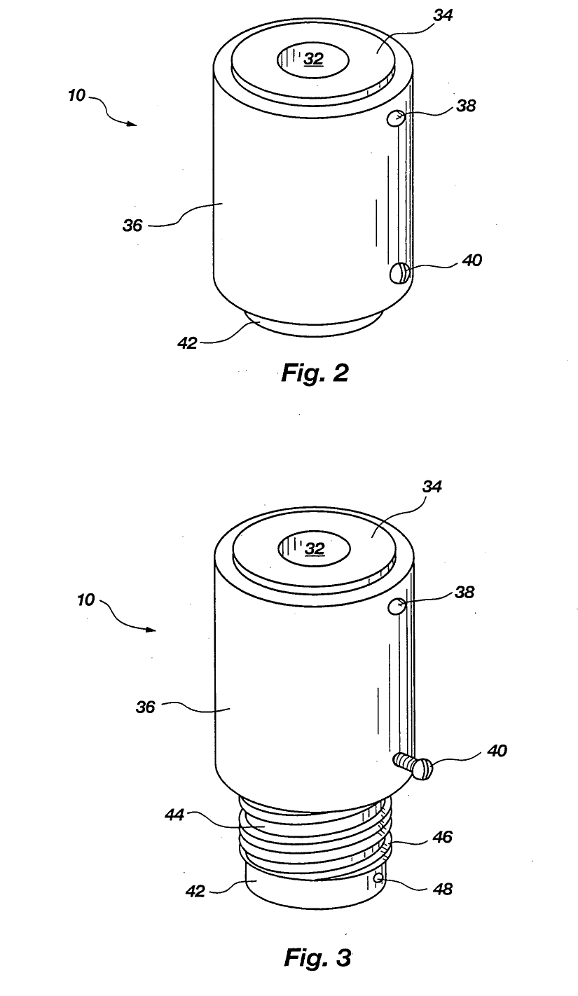

A take-up unit 10 is illustrated in a fully collapsed, minimum installed height, arrangement in FIG. 2. A bolt hole 32 receives a tie down bolt 16 of a commercially available hold-down system. The bearing surface 34 is typically configured to receive a retainer nut and washer, if desired (not shown). A recommended retainer nut includes a self locking mechanism, such as a nylon collar. As an alternative, a thread locking compound may also be used between the anchor bolt 16 and a retaining nut 18. A pair of retainer nuts may also be used as jam nuts in binding opposition.

The illustrated sliding member 36 has a hollow shape, and carries a spring retaining fastener 38 and a deployment trigger 40. The sliding member 36 may be formed integrally, or made and assembled as separate components, such as separate cap and shell portions (not shown). The sliding member 36 carries internal structure to interface in sliding and extending relation with the base member 42. A trigger 40 may be fashioned as a pin or threaded fastener, or any other mechanism which performs as an adequate trigger. An exemplary trigger mechanism holds a unit in a pre-deployment, installation height until the unit is installed in a hold down system. Subsequent to such installation, the trigger is disengaged to allow automatic height extension of a unit. Such disengagement is preferably simple and may be accomplished in the field with a minimum of tools.

FIG. 3 illustrates a take-up unit 10 in an extended height configuration. A maximum extension height is determined, in part, by the strength of the material forming the sliding member 36, the base member 42, and the cross section of the interface structure therebetween. When the interface is fashioned as a thread, a sufficient amount of thread material must remain in engagement having a sufficient cross-section to carry the applied axial load. In addition, the load carried by a take-up unit may be applied eccentrically due to imperfections in the mounting structure or alignment of the anchor bolt.

Note also, in FIG. 3, that a deployment trigger mechanism 40 has been illustrated in an activated position. As illustrated, the trigger 40 is a threaded fastener. A fastener 40 may also serve as a motion limiting stop to prevent complete disassembly of a unit 10. To accomplish a motion limiting stop, a fastener 40 may be assembled in penetration through a sliding member 36 in such a way as to restrict the range of removal of a fastener 40. A portion of the fastener 40 would then remain in engagement with a gap 44 machined in the threads 46 carried by a base member 42. A sliding member 36 would be permitted to slide relative to a base member 42 only to the extent allowed by the fastener 40 in combination with a gap 44. Also visible in FIG. 3 is a socket 48, which receives the trigger mechanism 40 when a unit 10 is configured for installation height. A trigger 40, installed and seated in combination with a socket 48, prevents deployment of the unit 10 prior to installation in a hold down system.

The threads 46 are illustrated as being multi-start threads. Such a multiple-start thread configuration provides a larger change in height of a unit 10 for a given rotation of a sliding member 36 relative to a base member 42 than does a single-start thread configuration. Currently it is desirable to provide the members 36 and 42 having between a single-start thread and a four-start thread configuration. However, the number of thread starts may be increased to over eight, depending on the requirements of the application.

One trade-off to consider for a multi-start thread vs. a single-start thread is the tendency of a member 36 to slide backwards under load. In this context, “backwards” would be in the direction to decrease the height of a unit 10. A multi-start thread has a lesser resistance to sliding backwards, compared to a single-start thread of equivalent size, because the friction force generated between meshing threads is lessened by the increased contact angle possessed by a multi-start thread. The multi-start thread has an increased lead length, or travel per rotation, which is equivalent to a steeper ramp. The “ramp” formed by a thread increases in slope in a direct relationship with the number of thread starts.

Of course, the friction force between the members 36 and 42 can be increased by providing an interface surface having a higher coefficient of friction. One way to accomplish such an increase in friction would be to roughen the interface between mating thread surfaces. An alternative would be to create interlocking teeth on the threads, or mutually wavy threads. Such interlocking teeth would provide a discontinuous increase in height of a take-up unit under load.

Another alternative might incorporate a simple spring loaded ratchet device in the member 36 and a series of vertical steps machined across the member 42. In such an arrangement, the ratchet would engage the vertical steps, preventing “backward” movement. No Anti-Backing device or increased roughness surface treatment was needed in tests of the illustrated apparatus having a thread helix angle of about 5.5 degrees. The illustrated thread interface surface provides a smooth increase in height of a unit, where such height increase may be described as a continuous function of sliding displacement.

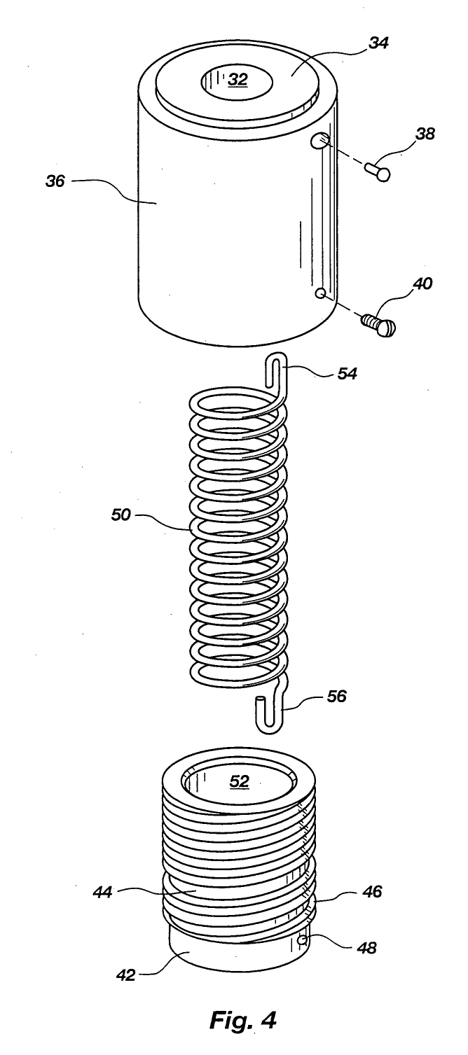

FIG. 4 is an exploded assembly view in perspective of a representative take-up unit 10. A bias element, such as a coil spring 50, is received interior to a bore 52. The spring 50 provides a practical, self-energizing source to slide a sliding member 36 relative to a base member 42, thereby to extend a take-up unit 10 in height. Other biasing elements are within contemplation. Any other bias element capable of performing the desired function of urging a base member 42 and a sliding member 36 in a direction to effect an increase in height of a unit 10 would be acceptable.

The tab 54 of a spring 50 may be configured to serve as a retaining structure to aid in assembly of a unit 10. During assembly, the spring 50 is inserted into a member 36 where the tab 54 receives a fastener 38 in retaining engagement. The tab 56 is then received by a slotted structure within the base member 42 to secure the tab 56 relative to the base member 42. The spring 50 may be shaped to be substantially symmetrical, providing equivalent structure at both ends. Such symmetry may simplify manufacturing. A preload may be applied to the spring 50 prior to engaging the sliding member 36 with the threads 46. The tabs 54 and 56 may rotationally anchor the spring 50 to the sliding and base members 36 and 42 to provide torsional force acting to twist the sliding and base members 36 and 42 apart.

Still with reference to FIG. 4 and continuing the assembly procedure, a member 36 is then slid relative to a member 42 (by rotating one member relative to the other) until the trigger 40 may be engaged within the socket 48. Following these assembly steps, the tie-down unit 10 is armed, pre-loaded, and ready for installation in a wall hold-down fastening system.

After installing a unit 10 over an anchor bolt 16 (FIG. 1) and securing it with a retainer nut 18, the trigger 40 is released from engagement with the socket 48. The unit 10 is then ready to extend in length and automatically take up slack as the wood elements shrink. If the unit 10 is accidentally activated without being secured by a retainer nut, engagement of the structure of the partially withdrawn trigger 40 with the end of a slot 44 will prevent unintended disassembly of the unit. One reason to prevent such unwanted disassembly is to ensure that a proper preload will be maintained in the spring 50.

Preventing disassembly by engaging a safety mechanism after correct spring preload is established is a feature which may be included in practice of the instant invention. FIG. 4 also illustrates how a sliding element 36 may form a protective shield for the unexposed portion of threads carried by the base element 42, as well as the internal spring 50. The unexposed portion of threads may be regarded as an advancing interface. As the interface advances, an additional increase in take-up unit height is accomplished.

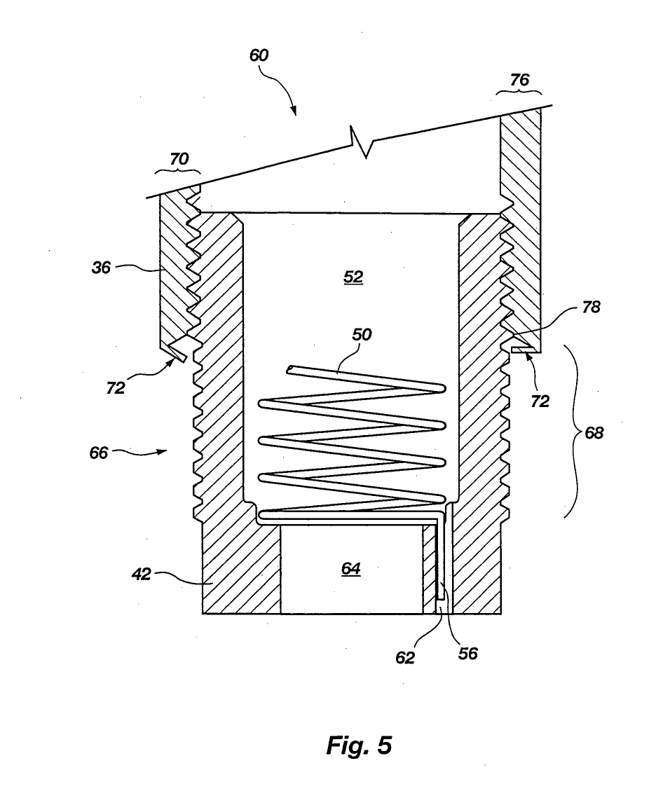

FIG. 5 illustrates an alternative apparatus according to the present invention. A portion of an alternative take-up unit 60 is illustrated in a cross-sectional view in elevation. The spring end tab 56 may be embodied as a straight pin end received in a slot structure embodied as a hole 62. Again, a spring 50 (only a portion of which is shown in FIG. 5) may be symmetric for ease of manufacture. An anchor bolt slidingly passes through the illustrated hole 64, formed in a base member 42, upon assembly of a unit 60 in a hold-down system. The threads 66 may include a section of trimmed threads 68 wherein the tips of the trimmed threads have been removed to create a threaded section 68 having a reduced diameter.

A portion indicated by the bracket 70 of the sliding member 36 represents a sliding member 36 prior to assembly as a take-up unit 10. Prior to assembly, the end flange 72 protrudes at an angle and thereby clears all threads carried by the base member 42 during the assembly of a unit 60. The portion indicated by the bracket 76 of a sliding member 36 represents the configuration of a member 36 after the unit 60 is fully assembled and then substantially expanded in height. Note that the flange 72 has been deformed during the assembly procedure to be horizontal and in position to interfere with the thread tip 78.

During assembly of a unit 60, a sliding member 36 is threaded over a base member 42 until the flange 72 clears the threaded section 68. A flange 72 is then “canned” or deformed to lie substantially in a plane perpendicular to an axis of a take-up unit 60. The flange 72 has a reduced inner diameter subsequent to the canning operation. The reduced diameter is such that an interference is created with untrimmed thread tips such as the thread tip 78. The interference created between the flange 72 and the thread tip 78 is another way to provide a safety mechanism to prevent inadvertent disassembly of a take-up unit. In the alternative, the flange 72 may be replaced by a separate snap ring (not shown) that can be interference fitted or otherwise attached to the sliding member 36 during assembly. The snap ring would then interfere with untrimmed thread tips in the same fashion as the flange 72.

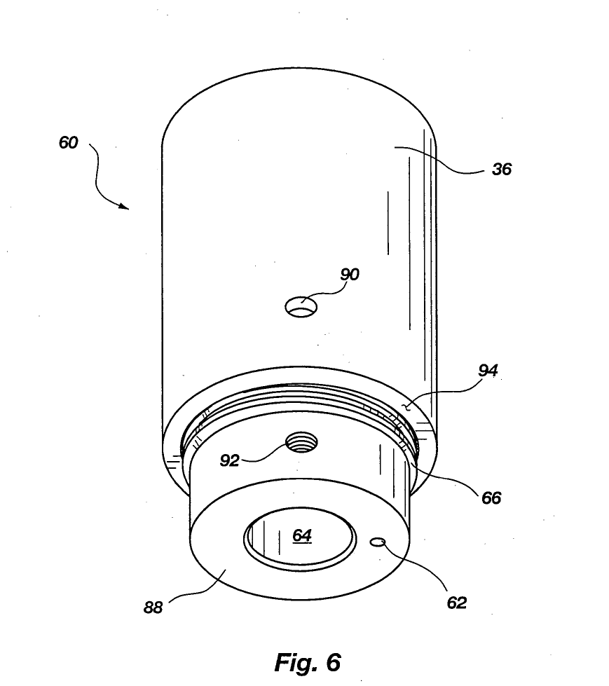

FIG. 6 illustrates a take-up unit 60 in a perspective view from below. The illustrated unit has been activated to provide automatic height adjustment, and is partially extended. The bottom bearing surface 88 has a through hole 62 to receive a tab 56 from an internal spring 50 (see FIG. 4). An alternate safety trigger mechanism is provided in the illustrated apparatus of FIG. 6. An oversize hole 90 slidingly receives a fastener or actuation trigger (not shown) for engagement with the receiving hole 92. In the alternative, the oversize hole 90 may have threads to engage the actuation trigger, and the receiving hole 92 may be made smooth to slidingly receive the trigger. With a fastener installed through the hole 90 and secured in the hole 92, the unit 60 is in a configuration ready for installation in a wall hold down system. The fastener or actuation trigger is removed after such installation to activate the automatic height adjusting capability of the unit 60. In this embodiment of a take-up unit 60, if the fastener or trigger were accidentally removed prior to installation, the flange 72 (seen in FIG. 6 as the surface 94) would prevent undesired separation of the members 36 and 42.

It is within contemplation for a flange 72 to have alternative configurations which accomplish the same purpose as a safety mechanism. One alternative configuration might include discontinuous flange sections around the circumference of a member 36, rather than forming one uninterrupted circular section, as illustrated in FIG. 6. Another configuration might include an alternative flange as a section that may be canned after final assembly to register into a discontinuous helical groove within a base member 42. Such a configuration combines aspects of the flange 72 of FIG. 5 and the trigger mechanism interface with the groove 44 of FIGS. 3 and 4.

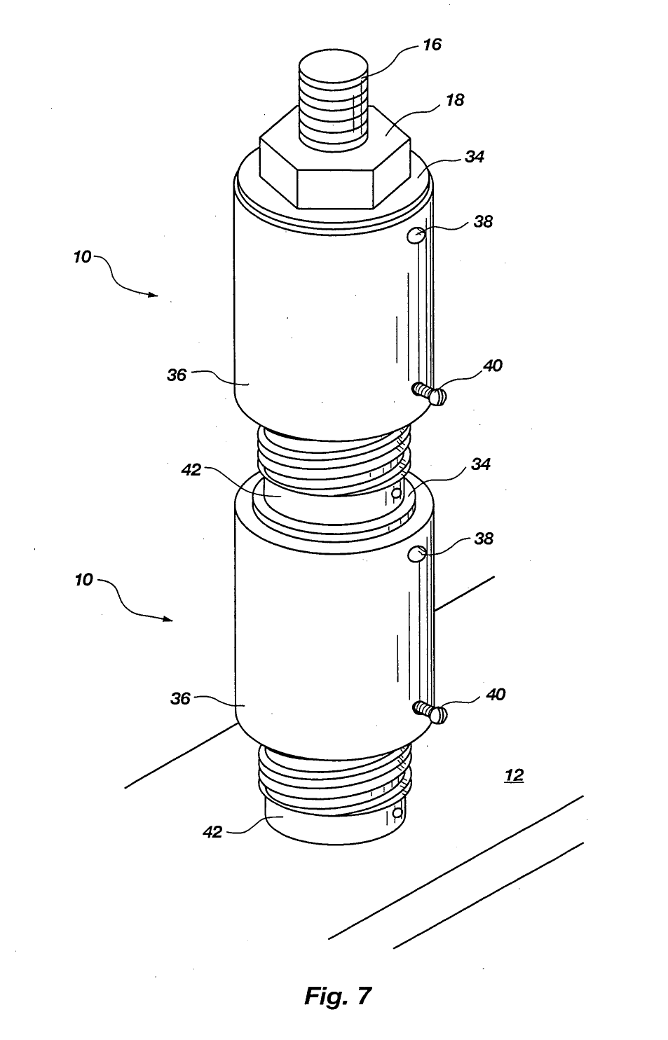

In situations where expected wood shrinkage or crushing might exceed the capacity of a single take-up unit, two or more units may be stacked in combination, as illustrated in FIG. 7. Such an in-line configuration provides an additive height extension capability. One circumstance where such increased capability might be desired is in the construction of a log cabin. The situation might also arise in conventional construction using platform framing with joists having an extra depth, or in attaching an upper story wall to a “remote” foundation.

The embodiments of the take-up units 10 and 60 provide a measure of protection to the internal mechanism of the units. The illustrated sliding members 36 provide a cover over threads thereby protecting the interface surface which may be used for further increase in unit height. Upon assembly with a retainer nut over a hole 32, the sliding member 36 forms a substantial shield from debris and corrosive elements. Take-up units are typically pre-lubricated with a dry lubricant prior to assembly further to promote smooth actuation over a long life. A life span of perhaps 30 years or more is appropriate for take-up units that may be enclosed within finished walls.

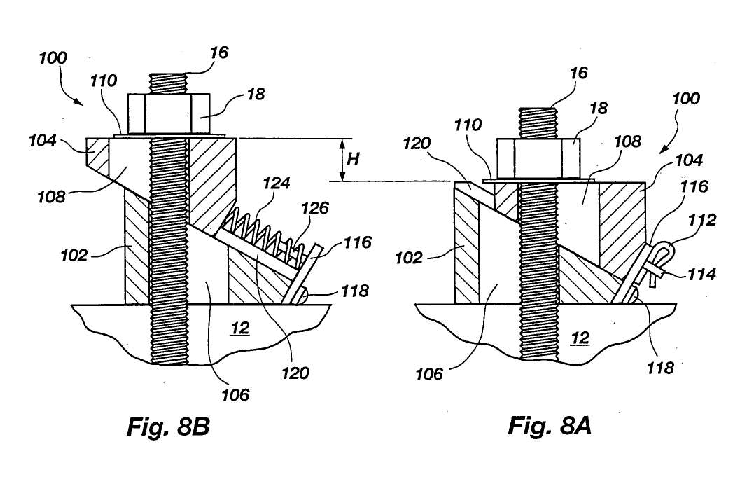

FIGS. 8A and 8B illustrate a third alternative embodiment of an apparatus in accordance with the invention, relying on translational movement between wedges; urged together using linear motion, instead of rotary motion. These Figures depict a sectional view in elevation taken through a midplane of the apparatus, and include an anchor bolt 16 for perspective. FIG. 8A illustrates the apparatus in a pre-deployment, minimum installed height, configuration. A ramp member 102 serves as a base and receives in sliding contact a complementary sliding ramp member 104. The slot 106 and the slot 108 are sized to receive an anchor bolt 16 and allow the ramp members 102 and 104 to slide relative to each other. In this embodiment, a washer 110 is typically included under a retaining nut 18.

Also illustrated in FIG. 8A is a deployment release trigger mechanism including a trigger 112 fashioned as a clevis pin. The release trigger 112 is received by one end of a retainer pin 114. The pin 114 is secured to a sliding member 104 on its opposite end. The trigger 112 through the pin 114 maintains a ramp member 102 in proximity to a thrust base 116, thereby preventing premature height extension of take-up unit 100. It is within contemplation to replace the pin 114 and the trigger 112 with a threaded fastener passing through a thrust base 116 and threading into the sliding member 104. An enlarged head section of such a fastener may be sized to not pass through the thrust base 116. Such an alternate trigger mechanism would simply be unscrewed from a sliding member 104 to deploy the take-up unit.

The thrust base 116 is illustrated as being structurally fixed to the base member 102 by one or more fasteners 118. The thrust base 116 may be secured to the base member 102 by any other appropriate fastening method, including without limitation, welding, interference fit, and adhesives. Furthermore, it is within contemplation also to machine an equivalent thrust base 116 directly from material forming the base member 102.

A sliding member 104 and a base member 102 are typically joined in a slidable capture arrangement, which prevents separation of the members in a height-increasing direction without a corresponding translation between base and sliding members. One arrangement to achieve such a result is illustrated as the dovetail joint structure 120 forming a dovetail joint between the members 102 and 104. Such a dovetail joint allows the members to slide relative each other in a height extending fashion, but prevents vertical separation of the members. In the case of an embodiment 100, a blind dovetail may be employed also to provide a safety mechanism to prevent a member 104 from sliding out of engagement with a member 102 in the event of inadvertent trigger release.

Many other configurations to accomplish a slidable capture feature are within contemplation. For instance, illustrated components, including a trigger 112, may serve as the capture feature, as well as a deployment release trigger mechanism. A thrust base 116, in combination with a pin 114 and a trigger 112 may provide sufficient restraint from member separation prior to installation of a unit 100 in a wall hold down system. Threads between the sliding and base members 36 and 42 of the first embodiment 10 (FIG. 4) also serve as such a slidable capture interface. Engaged threads prevent axial translation of separate members without also producing a corresponding sliding motion.

With continued reference to FIG. 8A, it is preferred that a guide structure of some sort be provided to prevent twisting of the base member 102 and sliding member 104 relative to each other. The illustrated dovetail joint structure 120 also provides such a guiding restraint. A simple box joint also would serve as a sufficient restraint. In a box joint configuration, the member 104 may be structured as a cap, having a slot in which a member 102 may slide. The converse configuration is also workable, wherein a base member 102 provides a slot in which a sliding member 104 may slide.

With reference to FIG. 8B, additional details, including the self-energized, height-extension capability of a take-up unit 100 may be seen. The arrangement illustrated in FIG. 8B represents a unit 100 configured for a maximum installed height. An anchor bolt 16 prevents the base and sliding members 102 and 104 from separating by sliding apart. The configurations of FIGS. 8A and 8B together demonstrate the maximum take-up height of which a single installed unit 100 is capable. Of course, two or more such units may be stacked end-to-end to achieve a greater take-up height.

Certain embodiments of a take-up unit 100 will have structure to prevent backwards movement of the sliding member 104 relative to the base member 102. As with the rotationally actuated take-up units 10 and 60, “backwards” means motion of a sliding member 104 and a base member 102 such that the overall height of the unit is reduced. In the case of a complement ramp structure, as illustrated in the unit 100, the ramp slope may be formed at such an angle that the frictional force generated between the ramp members 102 and 104 is adequate to prevent such undesired backwards travel. In certain situations, the interfacing surfaces between members may be formed to have indexing teeth, similar to steps or ratcheting gear teeth. Alternatively, a spring loaded pawl mechanism may be carried by one member to interface in structural interference with teeth or other structure including serrations carried by the other member.

In general, a unit 100 includes at least one, or a matched pair of, compression springs 124 to provide an automatic height extension force when deployed in a wall hold down system. The springs 124 each are received within a socket in the sliding member 102 (not shown) and are loaded in compression during assembly of a unit 100. A locating dowel 126 may aid in securing the free end of each spring 124 as the sliding member is placed into an assembled, deployment configuration. The preload created by the springs 124 is countered by a trigger mechanism, including the trigger 112 in combination with a pin 114 and the thrust base 116, prior to deployment of the unit.

Take-up units as illustrated and described may be manufactured from any suitable material, including ferrous and nonferrous metals. At times, stainless steels may be preferred in certain applications, particularly in corrosive or damp environments. Costs may be reduced in certain instances by the use of mild carbon steels. The strength of a take-up unit is generally designed to exceed the strength of other components of the hold down system, such as the anchor bolt.

A take-up unit 10, 60, such as embodiments illustrated, is typically installed as a separate element, independent of threaded retaining elements of a hold down system. However it is within contemplation also to provide a standard, right-hand, threaded hole 32 (FIG. 2) to interface with an anchor bolt 16. In such a configuration, a retainer nut may serve as a jam nut, fixing the element 36 from rotation relative to an anchor bolt 16. Such a configuration is presently considered less desirable because it removes one degree of rotational freedom from a take-up unit.

With a jam nut restraining the sliding member 36, only the base member 42 need rotate to extend a unit in height. While still workable, such a configuration may be less reliable than simply allowing both the base and sliding members 36 and 42 to rotate independently from the anchoring system. In the configuration having a threaded hole 32, it is often desirable to provide a left hand thread between the base and sliding members 36 and 42 to prevent rotating the sliding member 36 about an anchor bolt 16 under action of the self energizing spring 50. An apparatus having similarly directed threads in both the hole 32 and between sliding members may potentially and undesirably unscrew itself from the anchor bolt.

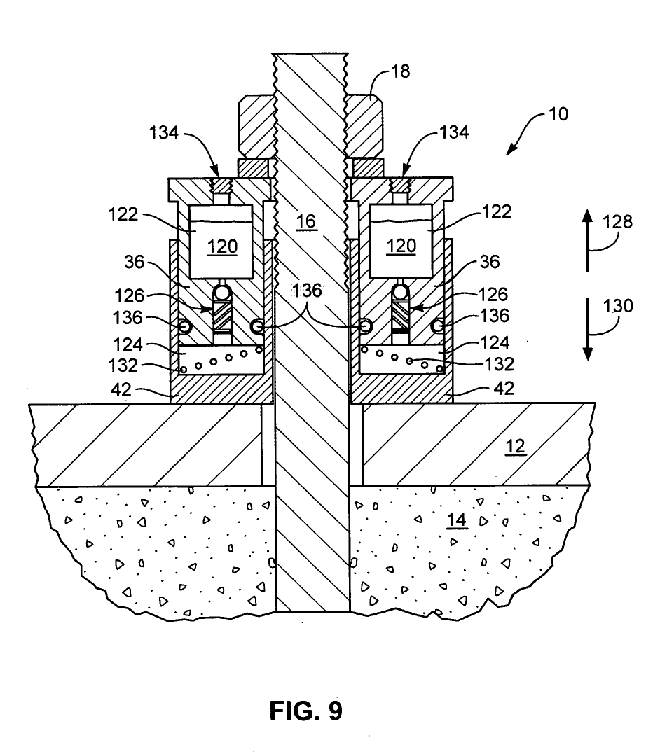

Referring to FIG. 9, in another embodiment, a hydraulic version of a take-up unit 10 may include a slide member 36, functioning as a piston 36, and a base member 42, functioning as a cylinder 42, or vice versa. To compensate for shrinkage, crushing, and the like, hydraulic fluid 120 may be transferred from a first cavity 122 within the slide member 36 (or elsewhere) to a second cavity 124 between the slide member 36 and the base member 42. A check valve 126 may typically be used to control the flow to ensure that hydraulic fluid 120 only flows from the first cavity 122 into the second cavity 124 and not vice versa. Accordingly, the slide member 36 may travel upward 128 with respect to the base member 42. However, the transfer of hydraulic fluid 120 combined with the action of the check valve 126 may resist travel of the slide member 36 downward 130 with respect to the base member 42.

In selected embodiments, a hydraulic take-up unit 10 may be placed around a tie rod 16 or an anchor bolt 16. Accordingly, a slide member 36, base member 42, first cavity 122 and second cavity 124 may have a generally annular shape. A tie rod 16 may engage a foundation 14 and extend therefrom through any number of wood structural members 12. Such structural members 12 may include, for example, sill plates, floor joists, floor panels, top plates, and the like. A retainer 18 (e.g. nut and lock-washer) may maintain the hydraulic take-up unit 10 firmly against the structural members 12 Accordingly, when loads are applied to the structural members 12, the loads may be transferred by the retainer 18, hydraulic take-up unit 10, and tie rod 16 down to the foundation 14.

However, when shrinkage or settling occurs, slack or gaps may appear between the retainer 18 and the hydraulic take-up unit 10. If such gaps are left unremedied, dynamic loads applied to the structural members 12 from winds, earthquakes, or the like will no longer be effectively and immediately transferred to the foundation 14. Accordingly, the connections or the entire building formed by the structural members 12 may be damaged or destroyed by the loads.

In selected embodiments, a spring 132 (in this embodiment a conically shaped coil spring 132) may be positioned between the base member 42 and the slide member 36. The spring 132 may urge the slide member 36 upward 128 to take-up any slack or gap between the retainer 18 and the take-up unit 10. In certain embodiments, moving the slide member 36 upward 128 causes the second cavity 124 to grow in volume. This may lower the pressure within the second cavity 124. The hydraulic fluid 120 within the first cavity 122 may then be drawn through the check valve 126 into the second cavity 124.

In selected embodiments, a vent 134 may fluidly connect the first cavity 122 to the surrounding environment. This may equalize the pressure drop occurring as a result of hydraulic fluid 120 flowing out of the first cavity 122, thereby allowing hydraulic fluid 120 to flow unimpeded into the second cavity 124. A seal 40 may be used to prevent hydraulic fluid 120 from leaking between the slide member 36 and the base member 42. For example, in selected embodiments, recesses may be formed in the sides of the slide member 36, or the base member 42, to accommodate one or more O-rings 136 or other seals 136.

Once the spring 132 has urged the slide member 36 upward 128 until it makes firm contact with the retainer 18, the retainer 18 may then stop the upward travel of the slide member 36. This may also stop the flow of hydraulic fluid 120 from the first cavity 122 into the second cavity 124.

When loads are subsequently applied to the structural members 12, the hydraulic take-up unit 10 may transfer the restraining force of the retainer 18 and tie rod 16 to the structural members 12. During such load transfers, the hydraulic take-up unit 10 resists compressive loads. Compressive loads may urge the slide member 36 in a downward direction 130 toward the structure held down by it. However, hydraulic fluid 120 inside the second cavity 124 resists such motion. Moreover, the check valve 126 resists or prevents hydraulic fluid 120 from exiting the second cavity 124. Thus, even if the seals 136 are not perfect, or the check valve 126, the hydraulic take-up unit 10 resists compressive loads.

If excess space is created between the hydraulic take-up unit 10 and the retainer 18, the spring 132 urges the slide member 36 upward 128. Hydraulic fluid 120 may then flow from the first cavity 122, through the check valve 126, and into the second cavity 124.

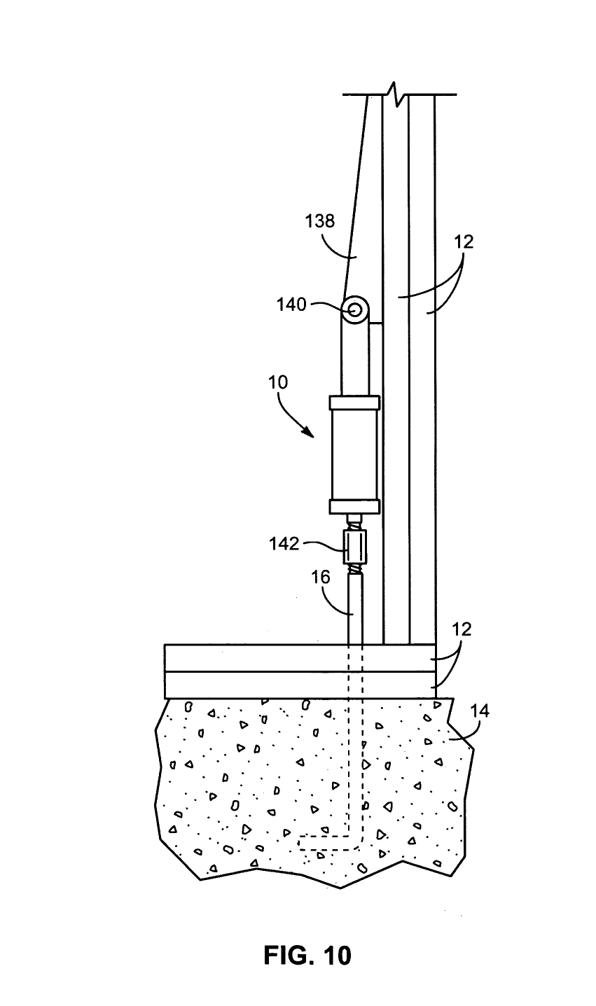

Referring to FIG. 10, in another embodiment, a hydraulic take-up unit 10 may extend from a hold down 138 or tie down 138 to a tie rod 16. For example, a hold down 138 may be secured to a structural member 12 such as a vertical stud 12. A bolt 140 may secure one end of the hydraulic take-up unit 10 to the hold down 138. In certain embodiments, a coupler 142 may secure the other end of the hydraulic take-up unit 10 to the tie rod 16.

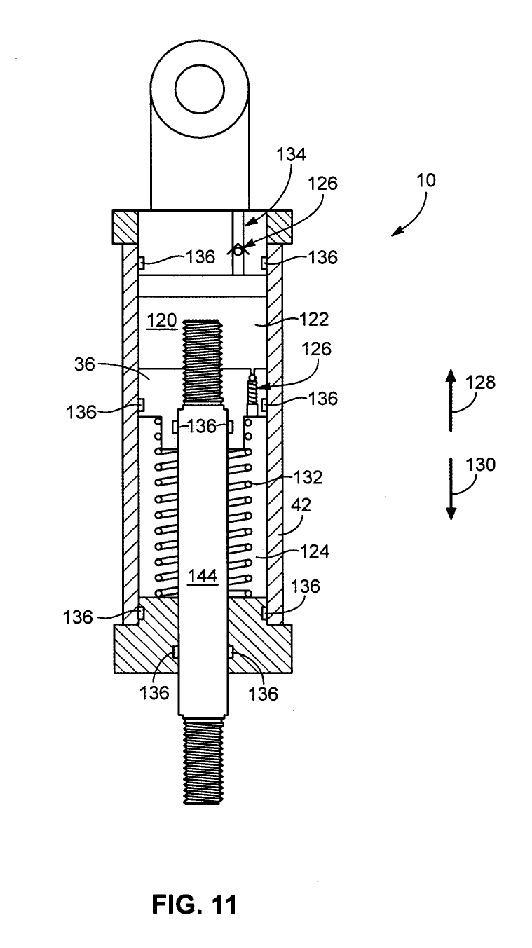

Referring to FIG. 11, a hydraulic take-up unit 10 extending between a hold down 138 and a tie rod 16 may function in much the same way as the hydraulic take-up unit illustrated in FIG. 9. That is, to compensate for shrinkage, crushing, and the like, hydraulic fluid 120 may be transferred from a first cavity 122 on one side of a slide member 36 (functioning as a piston 36) to a second cavity 124 on the other side of the slide member 36. A check valve 126 may control the flow of hydraulic fluid 120 to ensure that hydraulic fluid 120 only flows from the first cavity 122 to the second cavity 124 and not vice versa. Accordingly, the slide member 36 may travel upward 128 with respect to a base member 42, functioning as a cylinder 42. However, the transfer of hydraulic fluid 120 combined with the action of the check valve 126 may resist the downward travel 130 of the slide member 36 with respect to the base member 42.

When shrinkage occurs, a bolt 144 or the like extending through the second cavity 124 and engaging the slide member 36 may be pushed upward 128, thereby urging the slide member 36 upward 128. This upward movement causes the volume of the second cavity 124 to grow, thereby reducing the pressure inside the second cavity 124. Hydraulic fluid 120 inside the first cavity 122 may then be drawn through the check valve 126 and into the second cavity 124.

If desired, a spring 132 may be positioned inside the base member 42 to urge the slide member 36 upward 128. This may bias the hydraulic take-up unit 10 such that it creates a tensioned link between the tie rod 16 and the hold down 138. To facilitate the flow of hydraulic fluid 120 from the first cavity 122 into the second cavity 124, one or more vents 134 may fluidly connect the first cavity 122 to the surrounding environment. If desired, another check valve 126 may be positioned within the vent 134 to prevent the escape of hydraulic fluid 120. In selected embodiments, one or more recesses may be formed in the slide member 36, the base member 42, or both, to accommodate O-rings 136 or the like to provide seals between the various components of the take-up unit 10.

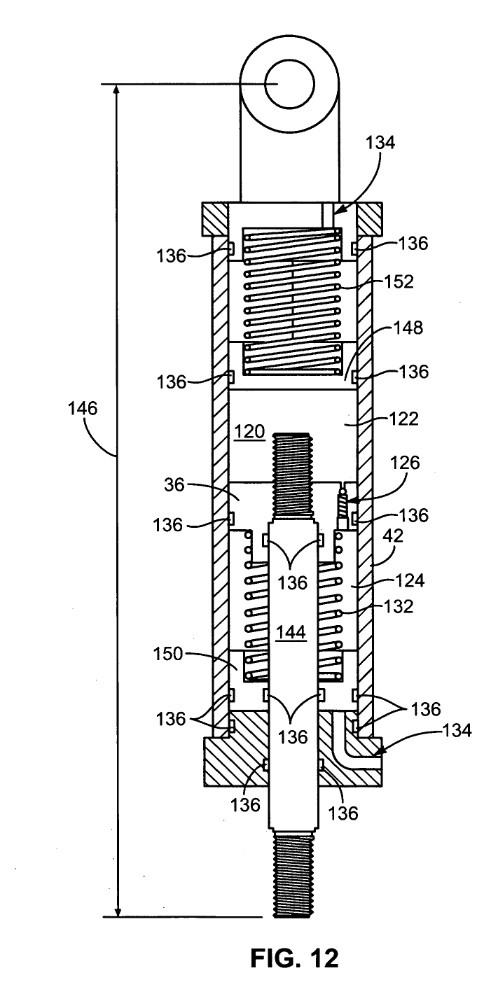

Referring to FIG. 12, in selected embodiments, it may be desirable to provide variability of the effective length 146 of a hydraulic take-up unit 10 in accordance with the present invention. For example, it may be desirable to permit a user to vary the length 146 between a bolt 144, coupled to a tie rod 16, and the other end of the take-up unit 10, secured to a hold down 138. This variability may facilitate and simplify the installation of a take-up unit 10.

In selected embodiments, first and second cavities 122, 124 may be permitted limited motion within the base member 42, or cylinder 42. This may be accomplished by providing two pistons 148, 150, in addition to the slide member 36 (which functions as a third piston 36). The slide member 36 may fulfill the same functions discussed with respect to FIGS. 10 and 11. A first piston 148 may, in combination with the base member 42 and the slide member 36, form a first cavity 122. A second piston 150 may, in combination with the base member 42 and the slide member 36, form a second cavity 124. Because the first and second pistons 148, 150 and the slide member 36 are able to move upward and downward relative to the base member 42, this allows the first and second cavities 122, 124 to move relative to the base member 42.

In certain embodiments, a spring 152 may urge the first piston 148 downward. This bias may be transferred by the hydraulic fluid 120 to the slide member 36 and the second piston 150. Accordingly, the second piston 150 may be urged to a position where further downward 26 movement is resisted. However, upward motion of the two pistons 148, 150 and the slide member 36 may still be permitted relative to the base member 42. This allows the bolt 144 to be lifted upward to enable the take-up unit 10 to be coupled to a tie bolt 16.

If, however, the bolt 144 is lifted up for too long of a period, the bias produced by the spring 152 will force hydraulic fluid 120 from the first cavity 122 into the second cavity 124 This transfer will continue until hydraulic fluid 120 inside the first cavity 122 is exhausted or the second piston 150 travels downward until additional downward movement is resisted.

To facilitate the flow of hydraulic fluid 120 from the first cavity 122 to the second cavity 124 and the movement of the first and second pistons 148, 150, one or more vents 134 to the surrounding environment may be connected to the volumes behind the first and second pistons 148, 150. Additionally, as discussed hereinabove, recesses may be formed in the slide member 36, base member 42, pistons 148, 150, or combinations thereof, to accommodate one or more O-rings 136 to provide seals between various components of the take-up unit 10.

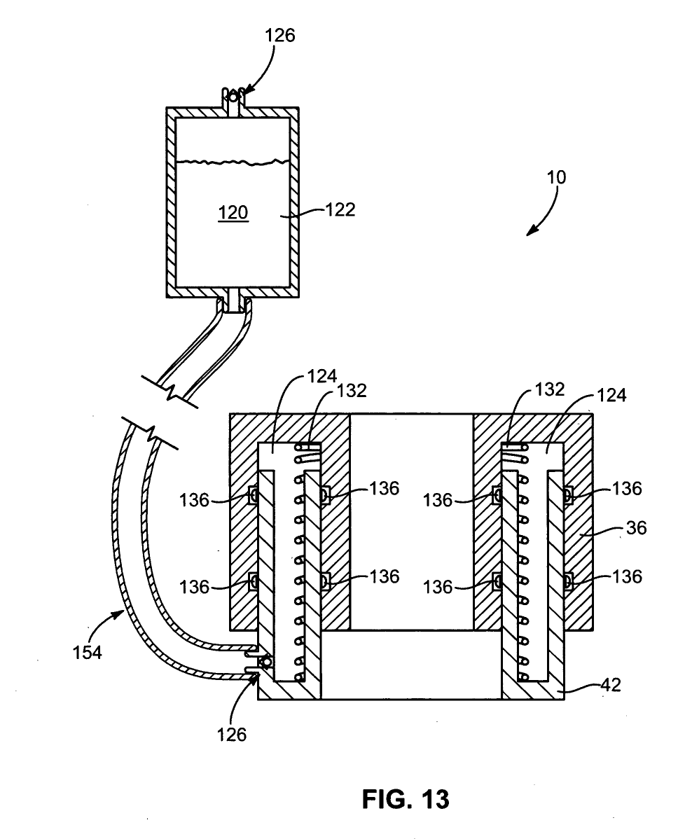

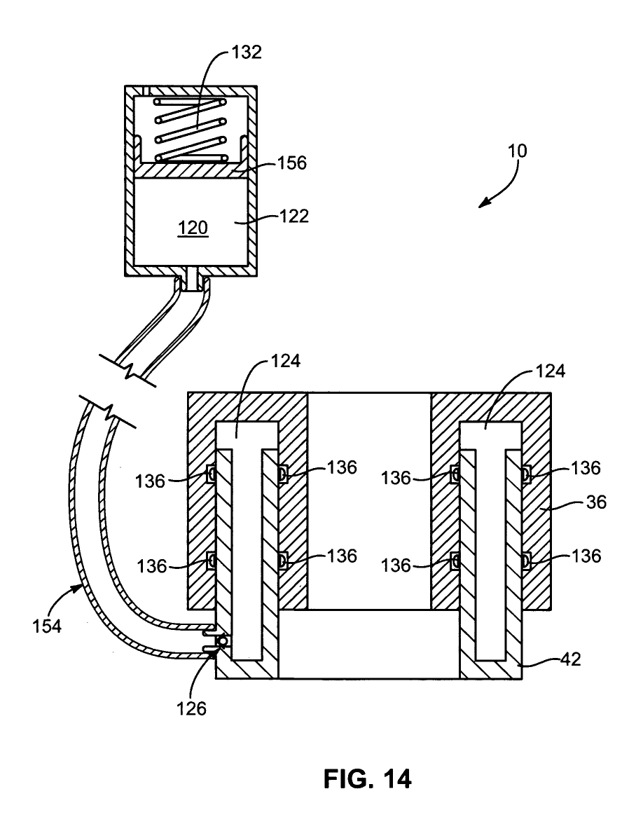

Referring to FIGS. 13 and 14, in selected embodiments, a first cavity 122 or reservoir 122 may be located apart from the take-up unit 10. For example, in some embodiments, a first cavity 122 may be connected to a second cavity 124 by way of a tube 154. The tube 154 may be formed of any suitable material and be of any suitable length.

In certain embodiments (e.g., see FIG. 13), a second cavity 124 may include a spring 132. The spring 132 may bias a base member 42 relative to a slide member 36 and may urge the second cavity 124 to increase in volume. Such an increase may tend to lower the pressure of hydraulic fluid 120 inside the second cavity 124 This may in turn draw in hydraulic fluid 120 from the first cavity 122. A check valve 126 may resist or prevent fluid 120 from exiting the second cavity 124 once it enters. Another check valve 126 may be used to vent the first cavity 122 while preventing the escape of hydraulic fluid 120.

In other embodiments (FIG. 14), a first cavity 122 may include a spring 132. The spring 132 may bias a piston 156 inside the first cavity 122, which may then urge hydraulic fluid 120 out of the first cavity 122 and into a second cavity 124. This allows the spring 132 to push hydraulic fluid 120 from the first cavity 122 into the second cavity 124 when distance is added between a take-up unit 10 and a retainer 18. A check valve 126 may be used to prevent hydraulic fluid 120 from exiting the second cavity 124 once it enters.

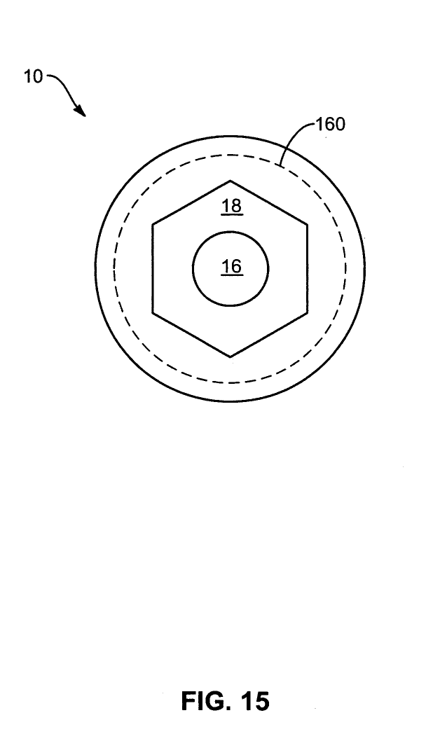

Referring to FIG. 15, one notable feature of the take-up units 10 described herein, including both the threaded take-up units 10 illustrated in FIGS. 1 through 7 and the hydraulic take-up units 10 illustrated in FIGS. 9 through 14, is their load distribution characteristics. The base members 42 of both the threaded and hydraulic take-up units 10 described herein provide substantially balanced and uniform axial support to the slide member 36 all along a substantially circumferential direction 160 regardless of the height of the take-up units 10. That is, even as the take-up units 10 expand (i.e., increase in height) over time, the base member 42 continues to provide substantially balanced and uniform axial support to the slide member 36 along a circumferential direction 160.

For example, with respect to the threaded take-up units 10 illustrated in FIGS. 1 through 7, the threads 66 of the base member 42 provide substantially uniform circumferential support to the threads of the slide member 36. This remains true even as the slide member 36 rotates and moves axially with respect to the base member 42. Likewise, with respect to the hydraulic take-up units 10 illustrated in FIGS. 9 through 14, the hydraulic fluid 120 between the base member 42 and the slide member 36 (i.e., in the second cavity 124) provides substantially uniform and balanced axial support to the slide member 36 along a circumferential direction 160. This remains true even as the slide member 36 slides axially with respect to the base member 42 as hydraulic fluid enters the second cavity 124. This ability to distribute a load evenly along a circumferential direction 160, regardless of the height of the take-up unit 10, represents a significant advance over prior take-up devices. Because of the uniformity of circumferential distribution 160 of axial loads, the take-up units 10 may be stronger and more stable without stress risers to initiate premature failures.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus, expandable axially along an anchor between a surface and a retainer:
fastened to the anchor, the apparatus comprising:
a base member;
a slide member adapted to slide relative to the base member to effect a change in height of the apparatus;
a load-transfer mechanism to transfer a load from the base member to the slide member, the load-transfer mechanism providing substantially balanced axial support to the slide member along a circumferential direction regardless of the height of the apparatus; and
a biasing member to urge the slide member with respect to the base member to increase the height of the apparatus.

2. The apparatus of claim 1, wherein the height of the apparatus is continuously adjustable.

3. The apparatus of claim 1, wherein the biasing member is a cylindrically-shaped coil spring.

4. The apparatus of claim 1, wherein the biasing member is substantially enclosed within at least one of the base member and the slide member.

5. The apparatus of claim 1, wherein the load-transfer mechanism comprises a hydraulic fluid reservoir inside at least one of the base member and the slide member.

6. The apparatus of claim 5, wherein the load-transfer mechanism further comprises a sealed cavity formed by the base member and the slide member, the volume of the sealed cavity changing upon sliding the slide member with respect to the base member.

7. The apparatus of claim 6, wherein the load-transfer mechanism further comprises a channel connecting the hydraulic fluid reservoir to the sealed cavity.

8. The apparatus of claim 7, wherein the load-transfer mechanism further comprises a valve allowing hydraulic fluid to flow from the hydraulic fluid reservoir to the sealed cavity through the channel, while preventing a return flow through the channel.

9. The apparatus of claim 1, wherein the load-transfer mechanism comprises mutually engageable threads on the base member and the slide member.

10. The apparatus of claim 9, wherein the threads enable multiple revolutions of the slide member relative to the base member.

11. An apparatus, expandable axially along an anchor between a surface and a retainer fastened to the anchor, the apparatus comprising:
a base member;
a slide member adapted to slide relative to the base member to effect a change in height of the apparatus;
a load-transfer mechanism to transfer a load from the base member to the slide member, the load-transfer mechanism providing an axial load distributed substantially uniformly along a circumferential direction thereof regardless of the height of the apparatus; and
a biasing member to urge the slide member with respect to the base member to increase the height of the apparatus.

12. The apparatus of claim 11, wherein the height of the apparatus is continuously adjustable.

13. The apparatus of claim 11, wherein the biasing member is substantially enclosed within at least one of the base member and the slide member.

14. The apparatus of claim 11, wherein the load-transfer mechanism comprises a hydraulic fluid reservoir inside at least one of the base member and the slide member.

15. The apparatus of claim 14, wherein the load-transfer mechanism further comprises a sealed cavity formed by the base member and the slide member, the volume of the sealed cavity changing upon sliding the slide member with respect to the base member.

16. The apparatus of claim 15, wherein the load-transfer mechanism further comprises a channel connecting the hydraulic fluid reservoir to the sealed cavity.

17. The apparatus of claim 16, wherein the load-transfer mechanism further comprises a valve allowing hydraulic fluid to flow from the hydraulic fluid reservoir to the sealed cavity through the channel, while preventing a return flow through the channel.

18. The apparatus of claim 1, wherein the load-transfer mechanism comprises mutually engageable threads on the base member and the slide member.

19. The apparatus of claim 18, wherein the threads enable multiple revolutions of the slide member relative to the base member.

20. An assembly comprising:
a structure comprising a foundation, a structural member, an anchor extending in a first direction from the foundation through the structural member, and a fastener engaging the anchor at a location spaced from the structural member in the first direction; and
a take-up unit to occupy excess distance between the structural member and the fastener, the take-up unit comprising:
a base member;
a slide member adapted to slide relative to the base member to effect a change in height of the take-up unit;
a load-transfer mechanism to transfer an axial load from the base member to the slide member and to distribute the axial load substantially uniformly along a circumferential direction regardless of the height of the apparatus; and
a biasing member to urge the slide member with respect to the base member to increase the height of the take-up unit.
